(19) United States
(12) Patent Application Publication
(10) Pub. No.: US 2005/0035263 A1
(43) Pub. Date: Feb. 17, 2005

(54) Devices that are used to support the poles of parasols, antennae and other elements

(76) Inventor: Cesar Colavecchi, Montlhery (FR)

Correspondence Address: PENDORF & CUTLIFF, 5111 MEMORIAL HIGHWAY, TAMPA, FL, 33634-7356, US

(21) Appl. No.: 10/493,120

(22) PCT Filed: Oct. 18, 2002
(86) PCT No.: PCT/FR02/03579

(30) Foreign Application Priority Data
Oct. 19, 2001 (FR) 01/13470

(51) Int. Cl. F16M 13/00

(52) U.S. Cl. 248/528

(57) ABSTRACT

The invention relates to improvements made to a support that is intended for the pole of a parasol, antenna, mast or other element. The inventive device is of the type that includes: at least three support legs which are subjected to a central force that tends to cause the legs to move towards one another, and means for opposing said movement, by means of which the legs move closer together. The means which are used to oppose the aforementioned movement comprise adjustable end pieces which rest on the sleeve that is intended to receive the pole and to which the legs are articulated.

### CROSS REFERENCE TO RELATED APPLICATION

The present application is a national stage of PCT/FR02/03579 filed Oct. 18, 2002, and based upon French Application No. 01/13470 filed Oct. 19, 2001 under the International Convention.

### FIELD OF THE INVENTION

The object of the present invention is the improvement of support devices of umbrella poles or others and, more particularly, improvement of Patent 97.07762 (2 757 356), filed by the same Applicant on Jun. 23, 1997.

### DESCRIPTION OF THE PRIOR ART

In this patent, an umbrella support was described having at least three legs and which carries at the same time a central ballast having a tendency to make the said legs approach and, on the other hand, means that oppose this approaching movement, these two antagonistic forces providing excellent stability to the umbrella support.

The present invention concerns improvements to this Patent 97.07762.

### SUMMARY OF THE INVENTION

The first improvement consists in making the separation of the legs adjustable.

The second improvement consists in producing the said legs, so that they have good resistance to forces of longitudinal flexion, while having a relatively low torsional resistance, so as not to fold under the effect of a gust of wind; however, to be able to twist slightly over themselves, which permits counteraction of the effect of a gust of wind.

The third improvement consists in replacing the central ballast by a controllable central anchorage.

The fourth improvement consists in equipping the ends of each support leg with a floating buoy and to provide to the holding of the central ballast a length and a density such that it will be immersed in water.

The fifth improvement consists in equipping the end of each support leg with a pivoting extension piece.

### BRIEF DESCRIPTION OF THE DRAWINGS

The attached drawings are presented as non limiting examples and to aid the comprehension of the invention:

FIG. 1 is a detailed perspective view illustrating the attachments of the legs to the sleeve tube receiving the rod.

FIG. 2 is an elevation of a detail of FIG. 1, illustrating the adjustable means of support of a support leg.

FIG. 3 is a perspective view illustrating the structure of a support leg.

FIG. 4 is a partial view of FIG. 1 from above.

FIG. 5 is a variation of embodiment.

FIGS. 6 and 7 are two variations of FIG. 5.

FIG. 8 is a view illustrating another variation of FIG. 7.

FIG. 9 is a view illustrating another embodiment of the invention.

FIG. 10 is a view illustrating a variation of the realization of the legs of the support.

### DESCRIPTION OF THE INVENTION

As it was explained in Patent 97.07762, the support device of a pole has at the same time means for making the legs of the support approach one another and means to oppose such a movement.

In Patent 97.07762, the means tending to make the support legs approach is a ballast consisting of a sack hanging on the said support legs and the means opposing this movement are rocker bars.

The disadvantage of this arrangement is that, with the rocker bars having a fixed length of separation, the support legs are not adjustable.

The first objective of the present invention is to eliminate this disadvantage.

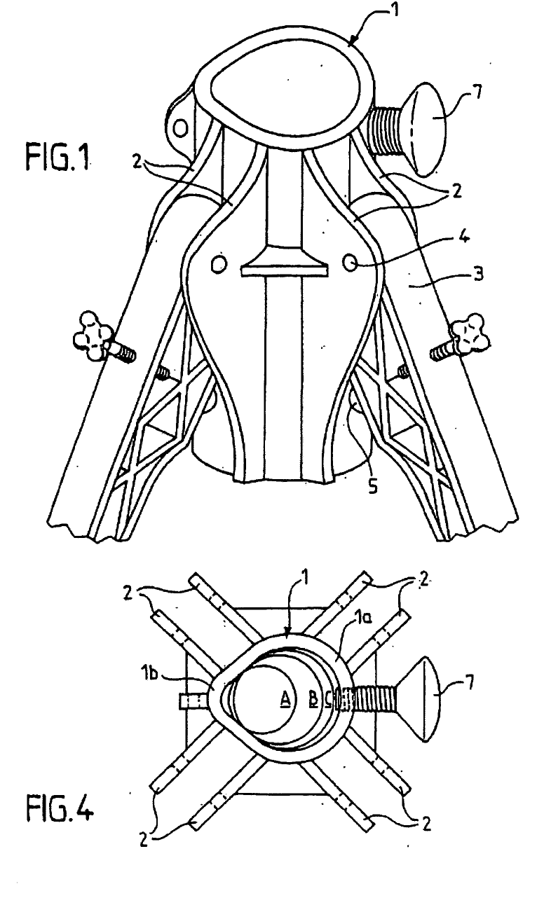

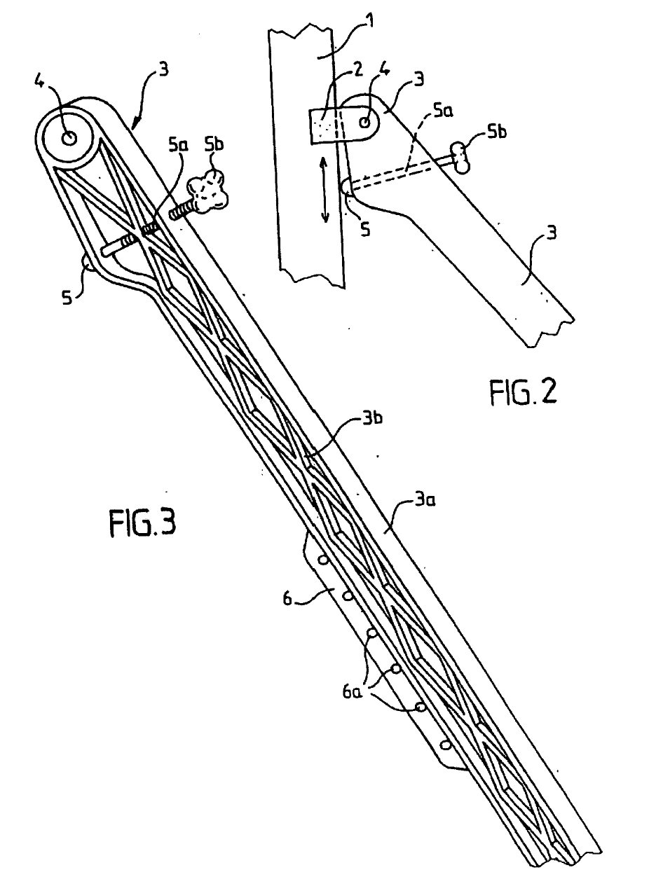

Referring to FIGS. 1 to 4, it can be seen that the support consists of a sleeve tube 1 equipped with four pairs of straps 2 on which four legs 3 are mounted with the aid of axle 4 in a pivoting manner.

Each support leg 3 has an end, which is supported against the sleeve tube and thus opposes the approach of the legs.

Each end 5 is adjustable, that is, it traverses support leg 3 via a threaded hole 5a and has a handle 5b.

Thus, by screwing in the threaded pole 5a, the support legs of the sleeve tube are separated and, conversely, they are made to approach by unscrewing it: thus, the separation of support legs 3 can be adjusted.

Each support leg 3 is equipped on its interior face with a small bar 6 having a number of holes 6a, which permits suspension of the ballast or any other analogous means in several locations.

Thus, it is possible to adjust both the separation of the support legs 3 with the aid of the adjustable ends 5 and the point of application of the force tending to make the support legs approach, using orifices 6a.

As it is illustrated in FIG. 3, each support leg 3 consists of two flat plates 3a, connected to one another by a bracing or analogous structure 3b having a smaller thickness.

It follows from this that each support leg 3 is very resistant to transversal flexion force, but less resistant to torsional forces, which permits the support to resist gusts of wind better.

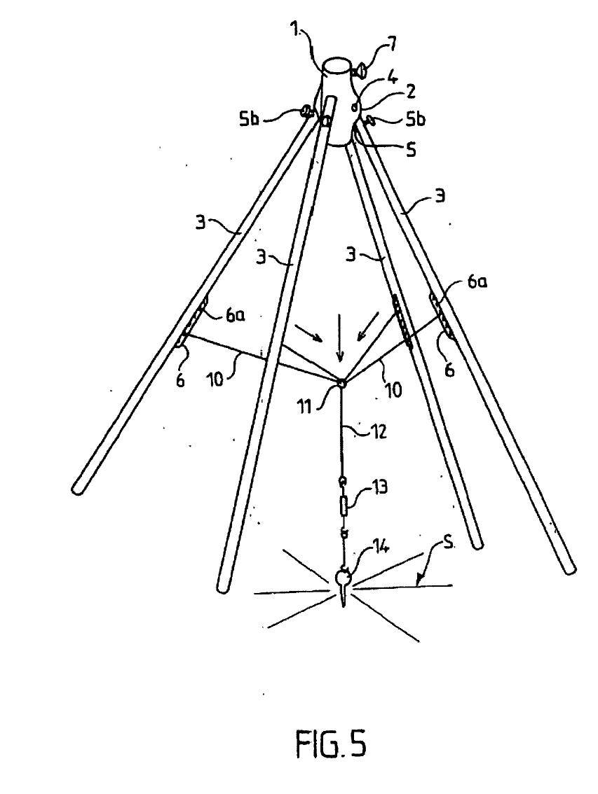

By referring to FIG. 1, it can be seen that the cross-section of the orifice of the sleeve tube intended to receive a pole is not a regular circle, but in part 1a (at the right on FIG. 4), a semi-circle, on which an oblong-shaped part 1b is attached. This arrangement permits blocking poles, such as A, B, C, of different diameters in position, with the aid of a blocking screw 7, located opposite the oblong shape 1b.

It should be pointed out that, both in the description of the prior patent 97.07762, as well as in it, in principle, mention is made that the support is intended to serve as a support to an umbrella; however, the invention is not limited to this particular usage. The support may serve to support any type of pole, such as the curtain rod, tent pole, the poles of television or parabolic antennae, poles carrying a signal panel or others, and this enumeration is not exhaustive.

According to another aspect of the present invention, the ballast described in Patent 97.07762 can be replaced by an anchorage as represented in FIGS. 5 to 8.

On these figures, the same elements as those of FIGS. 1 to 4 carry the same references.

On FIG. 5, it can be seen that the central ballast was replaced by an anchorage consisting of a ring 14 fixed in the floor, a cable 12 and a spanner 13; cable 12 is attached to a central ring 11 where cables 10, attached in orifices 6a of support legs 3, end.

Thus one finds, but in a different embodiment, a central means which has a tendency to make the support legs 3 approach and, in each support leg 3, there is a means (in the present case, adjustable end 5) which opposes this movement.

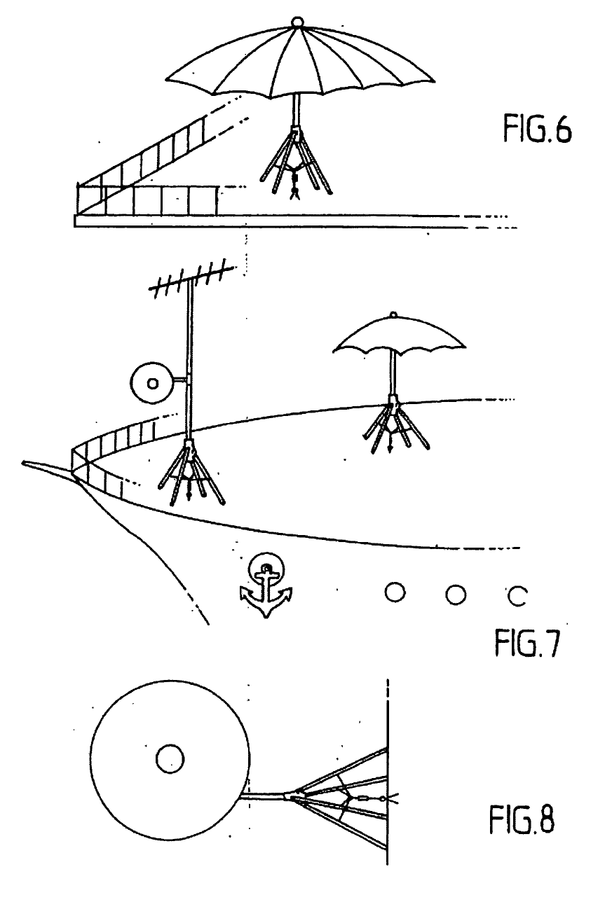

This arrangement permits numerous applications, such as that illustrated in FIGS. 6 to 8: attachment of an umbrella on a balcony (FIG. 6), or on the bridge of a boat (FIG. 7); attachment of an antenna (FIG. 7); attachment of a parabolic antenna on a vertical wall (FIG. 8).

Although this is not represented, one can also use an analogous device to that of FIG. 8 to attach the support to a ceiling, this support carrying a light fixture or others, for example, a decorative design.

This same arrangement permits anchoring the support to the floor and to fix there a pole to which an elastic band is attached to which a tennis ball or golf ball is attached.

In the case of a tennis ball, one can adjust the height to which the user wishes to play by adjusting, on the one hand, the height of the pole in sleeve tube 1 and, on the other hand, by the distance of support legs 3.

In the case of a golf ball, the support legs 3 can be separated to a maximum.

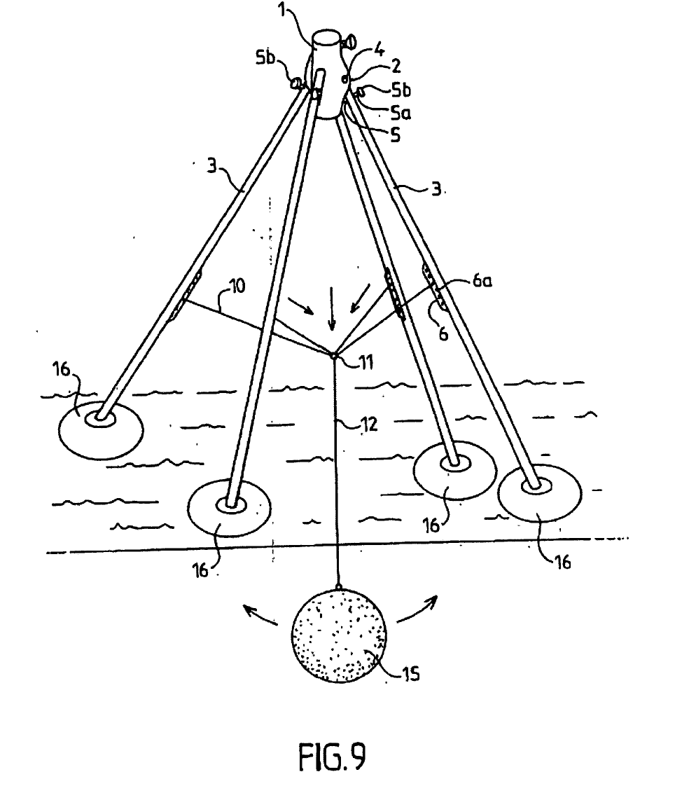

It can be seen on FIG. 9 that, according to another variation of realization, one can arrange floating buoys at the end of support legs 3 and attach, to the central ring 11, a cable 12 at the end of which a mass 15 of a density greater than that of water is suspended, analogously to a dead body, the said cable 12 having such a length that the mass 15 is immersed in the water, this mass being able to oscillate as a pendulum with respect to support legs 3 when there are waves.

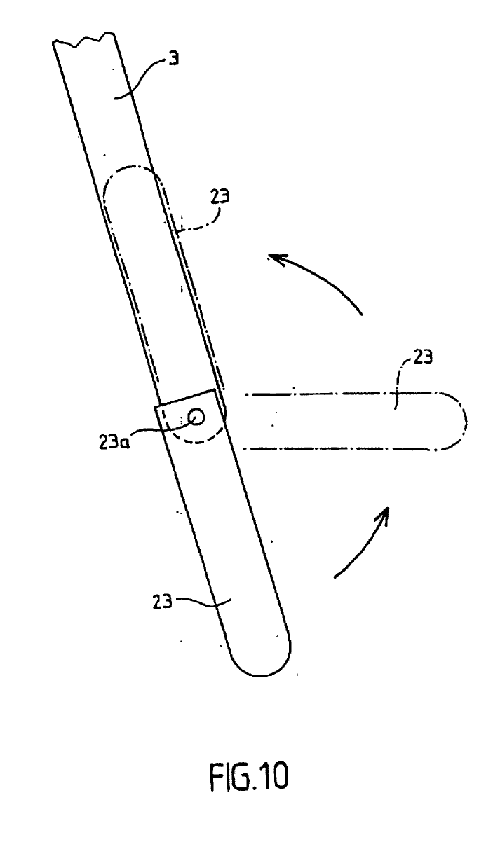

According to a variation of the embodiment illustrated schematically in FIG. 10, each leg 3 may carry an adjustable extension piece 23, which can pivot around an axis 23a, equipped with a means of sealing. For example, the axis 23a can be a screw equipped with a butterfly nut.

This arrangement has the following advantages:
by unfolding the extension pieces 23 completely, it is possible to modify the height of the support;
by blocking the extension piece pieces 23 in the horizontal position, it is possible to increase the footing of the support on the floor;
by blocking the extension piece pieces 23 in different angular positions, it is possible to place the support on an uneven terrain or on a slope while having the axis of sleeve tube 1 vertical.

In order to put away the support, the support legs 3 are folded back upward. The same is true for the extension pieces 23.

1-9. (cancelled)

10. A supporting pole for at least one of an umbrella, antennae, mast and others of the type comprising:
at least three supporting legs having a first end and a second end, wherein the at least three supporting legs are subjected to a central force on the first end, wherein the force cause an approach of the at least supporting legs; and
means located in the second end to oppose the approach of the at least supporting legs, wherein these means includes adjustable ends (5), which are supported against a sleeve tube (1) intended to receive the pole and on which the support legs (3) are articulated.

11. The support according to claim 10, wherein the means are chosen from a ballast (15) or an anchorage to the floor (14).

12. The support according to claim 11, wherein each support leg (3) carries, on an internal face, a number of orifices (6a) that permit approach of the means at different levels.

13. The support according to claim 10, wherein each support leg (3) includes two parallel plates (3a) connected to one another by bracing of a smaller thickness so as to have good resistance to flexion and less resistance to torsion.

14. The support according to claim 11, wherein the means of anchorage consist of an anchorage ring (14) attached to the floor, to which a cable (12) is connected, equipped with a spanner (13), the cable being attached to a central ring (11), where the different cables (10) attached to the orifices (6a) of the support legs (3) end.

15. The support according to claim 10, wherein each support leg (3) is equipped at its end with an extension piece (23) articulated on an axis (23a) and which can be immobilized in any desired angular position.

16. The support according to claim 14, wherein each support leg (3) is equipped with a floating buoy (16), the anchorage (14) being replaced by a mass (15) having a density greater than that of water, into which the said mass (15) is immersed so as to act as a pendular stabilizer.

17. The support according to claim 10, wherein the cross-section of the orifice of the sleeve tube has a semi-circular part (1a) and a part (1b), opposite, of an oblong form; the semi-circular part (1a) being equipped with a locking screw (7).

18. The support according to claim 14, wherein the support permits the attachment of multiple objects to the floor, vertical walls, below horizontal walls, umbrellas, television antennae, satellite reception parabolas, lamp posts, elastic bands for tennis balls or golf balls.
